(19) United States
(12) Patent Application Publication
(10) Pub. No.: US 2021/0304196 A1
(43) Pub. Date: Sep. 30, 2021

(54) SYSTEM AND METHOD FOR DIGITAL FASHION ASSET MANAGEMENT THROUGH BLOCKCHAIN

(71) Applicant: SneakrCred Inc., San Francisco, CA (US)

(72) Inventor: Casmir PATTERSON, San Francisco, CA (US)

(21) Appl. No.: 17/212,114

(22) Filed: Mar. 25, 2021

Related U.S. Application Data
(60) Provisional application No. 62/994,588, filed on Mar. 25, 2020.

(51) Int. Cl. G06Q 20/38; G06Q 20/06; G06Q 50/18

(52) U.S. Cl. CPC G06Q 20/389; G06Q 50/184; G06Q 20/0658

(57) ABSTRACT

A system and method for digital fashion asset management through blockchain. The system and method are robust enough to support strong asset mirroring and ownership control, yet are also flexible enough to support an authentic user experience. Rather than limiting the user in their interactions with an asset, the system and method instead support creative interactions within the boundaries established by a brand owner or overall asset manager. As used herein, the term “fashion asset” includes but is not limited to clothing, shoes, hats, belts, watches, jewelry, sunglasses, wallets, bags, purses and so forth.

### FIELD OF THE INVENTION

The present invention, in at least some embodiments, is of a system and method for fashion asset management through blockchain, and in particular, to such a system and method which supports virtual and digital fashion asset remixing and ownership control, as well as fashion asset management of physical assets.

### BACKGROUND OF THE INVENTION

Fashion assets are omnipresent in the physical world but are now transferring to the digital world. With such transfer, many issues have arisen, including authenticity, ownership, creative interactions, and overall control of the asset. Many of these issues also impact physical fashion assets, as wearers seek a more customized and personalized product. In both cases, fashion assets have become more of an experience; they are not only about the physical or digital product, but also about the experience of obtaining and interacting with that product.

Digital assets suffer particularly strongly from concerns over fraud and authentication on the one hand, and the desire for more creative interactions on the other hand. Owners of such digital assets, particularly brand owners, seek to control every aspect of the user's interaction with the asset. Users, on the other hand, seek more freedom in their interactions. Both brand owners and users suffer from lack of digital asset representation, so in that sense, both are aligned in their desire for mirroring their physical assets into their digital life.

In the physical world, “mirroring” was previously relatively easy to determine. Fraudulent products, or “knock offs”, were easier to spot, due to issues of poor quality and construction, or a clearly inferior design. However fraudulent products have become more sophisticated, making fakes harder to spot. The characteristics of digital assets offer even more opportunities for mirroring, which is even more difficult to control.

### BRIEF SUMMARY OF THE INVENTION

The background art does not teach or suggest a system and method for fashion asset management through blockchain. The background art also does not teach or suggest such a system and method for supporting an digital representation of user experience with the fashion asset, while also protecting the user from fraud. The background art also does not teach or suggest such a system and method which also supports mirroring of both physical and digital fashion assets.

The present invention, in at least some embodiments, overcomes these drawbacks of the background art by providing a system and method for fashion asset management through blockchain. The system and method are robust enough to support strong asset authentication and ownership control, yet are also flexible enough to support an authentic user experience. Rather than limiting the user in their interactions with an asset, the system and method instead support creative interactions within the boundaries established by a brand owner or overall asset manager.

According to at least some embodiments, the system and method support virtual and digital fashion asset remixing and ownership control. The system and method also optionally support fashion asset management of physical assets. Preferably, the system and method support a combination of fashion asset management for physical and digital assets, such that a physical asset may be connected to a digital asset. Alternatively, the digital assets are not connected to a physical asset.

As used herein, the term “fashion asset” includes but is not limited to clothing, shoes, hats, belts, watches, jewelry, sunglasses, wallets, bags, purses and so forth.

According to some embodiments, the system and method allows users to exchange and manage digital and physical goods that have a non-fungible token (NFT) associated with a physical good. The system and method allow users to create or purchase digital fashion goods from sellers, where the goods can be used, store, or exchange by the user. These goods can be stored within a standard Web3 wallet and ported in an out of gaming platform environments. This model allows for interoperability across Web3 systems.

According to some embodiments, the system and method allow users to exchange and manage digital and physical goods that have a non-fungible token associated with it on a marketplace or gaming platform. The system and method allow users to create or purchase digital fashion goods from sellers, where the goods can be used, store, or exchange by the user. These goods can be stored within a standard Web3 wallet and ported in an out of gaming platform environments. This model allows for interoperability across Web3 systems and also incorporates real-time off-chain data into it's smart contracts. The off-chain data is programmed to be Verifiably Random Data that enables it to be responsive to off-chain events like location data, gaming inputs and other social platform events data.

The process model for making physical and digital goods interoperable involving interchain NFTs. Gaming and immersive applications consume digital goods on chain allowing users the ability to express them as digital fashion or convert physical goods into digital artifacts. Users exchange the token associated with the object as it's underlying unique and recorded identity.

Blockchain is a particularly useful tool because it enables transparent authentication, which cannot be easily spoofed or otherwise copied. It also supports flexibility in user interactions, through the use of smart contracts as a way to allow the user to perform certain interactions automatically. For example, smart contracts may be used to permit the user to “remix” or otherwise change the digital fashion asset in certain ways, while blocking other changes by the user. Such creative interactions may be used for example to support game play involving the digital fashion asset.

Blockchain also supports interactions between physical fashion assets and the digital world. For example, if a location of a physical fashion asset is provided to the system through geolocation, a smart contract may be used to automatically execute an action according to the asset location. For example, if a physical fashion asset were to be present in a specific stadium, then access could be granted to a corresponding digital asset through execution of a smart contract.

Other solutions involving blockchain have been proposed for physical or digital shoes, such as U.S. patent Ser. No. 10/505,726 to Nike, Inc. This patent describes a very basic solution regarding recordation of ownership of shoes on a blockchain. However, the patent does not provide an authentic user experience, nor does it consider specific aspects of digital vs physical assets, instead treating them in the same way. For example, this patent does not consider geolocation with regard to physical assets. It also does not describe any type of flexibility in user interactions with an asset.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Unless otherwise defined, all technical and scientific terms used herein have the same meaning as commonly understood by one of ordinary skill in the art to which this invention belongs. The materials, methods, and examples provided herein are illustrative only and not intended to be limiting.

An algorithm as described herein may refer to any series of functions, steps, one or more methods or one or more processes, for example for performing data analysis.

Implementation of the apparatuses, devices, methods and systems of the present disclosure involve performing or completing certain selected tasks or steps manually, automatically, or a combination thereof. Specifically, several selected steps can be implemented by hardware or by software on an operating system, of a firmware, and/or a combination thereof. For example, as hardware, selected steps of at least some embodiments of the disclosure can be implemented as a chip or circuit (e.g., ASIC). As software, selected steps of at least some embodiments of the disclosure can be implemented as a number of software instructions being executed by a computer (e.g., a processor of the computer) using an operating system. In any case, selected steps of methods of at least some embodiments of the disclosure can be described as being performed by a processor, such as a computing platform for executing a plurality of instructions.

Software (e.g., an application, computer instructions) which is configured to perform (or cause to be performed) certain functionality may also be referred to as a “module” for performing that functionality, and also may be referred to a “processor” for performing such functionality. Thus, processor, according to some embodiments, may be a hardware component, or, according to some embodiments, a software component.

Further to this end, in some embodiments: a processor may also be referred to as a module; in some embodiments, a processor may comprise one or more modules; in some embodiments, a module may comprise computer instructions—which can be a set of instructions, an application, software—which are operable on a computational device (e.g., a processor) to cause the computational device to conduct and/or achieve one or more specific functionality.

Some embodiments are described with regard to a “computer,” a “computer network,” and/or a “computer operational on a computer network.” It is noted that any device featuring a processor (which may be referred to as “data processor”; “pre-processor” may also be referred to as “processor”) and the ability to execute one or more instructions may be described as a computer, a computational device, and a processor (e.g., see above), including but not limited to a personal computer (PC), a server, a cellular telephone, an IP telephone, a smart phone, a PDA (personal digital assistant), a thin client, a mobile communication device, a smart watch, head mounted display or other wearable that is able to communicate externally, a virtual or cloud based processor, a pager, and/or a similar device. Two or more of such devices in communication with each other may be a “computer network.”

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the drawings:

FIGS. 1A and 1B relate to a non-limiting, exemplary implementation for management of a fashion asset through blockchain according to at least some embodiments;

FIG. 2 shows a non-limiting exemplary system, again which supports reading from and writing to a plurality of different blockchain networks;

FIG. 3 shows a non-limiting exemplary method for enabling a user to customize a fashion item or asset, and to then have the certificate of ownership written to the blockchain;

FIG. 4 relates to a non-limiting exemplary method which is operative for a combined set of assets, which include physical and digital assets;

FIG. 5 shows a non-limiting exemplary method, which combines some of the previous embodiments involving interactions of multiple user computational devices with a server gateway that is able to access a plurality of different blockchains and is also able to access a game server to support gaming;

FIG. 6 shows a non-limiting exemplary system for supporting communication through a plurality of different blockchain components and across different blockchains;

FIG. 7A to 7C show a system 700 with a variety of components, which is preferably able to support gameplay through a plurality of blockchains and optionally through a plurality of engines;

FIG. 8 shows a non-limiting exemplary system in more detail for supporting various communications, including optionally smart contract execution;

FIG. 9 shows a non limiting exemplary method for supporting purchases of a digital fashion asset and then of writing that asset to a blockchain;

FIG. 10 is a non-limiting exemplary system for geolocation according to at least some embodiments;

FIG. 11 relates to a non-limiting exemplary geolocation method according to at least some embodiments; and

FIG. 12 shows a non-limiting, exemplary illustration of a scene from a game, featuring a digital fashion item.

### DESCRIPTION OF AT LEAST SOME EMBODIMENTS

According to at least some embodiments the blockchain is optionally a public or permissionless blockchain, such as Bitcoin or Ethereum, which is decentralized and which is a blockchain that anyone in the world can read, anyone in the world can send transactions to and expect to see them included if they are valid, and anyone in the world can participate in the consensus process for determining what blocks get added to the chain and what the current state is. As a substitute for centralized or quasi-centralized trust, public or permission-less blockchains are secured by cryptoeconomics—the combination of economic incentives and cryptographic verification using mechanisms such as proof of work or proof of stake, following a general principle that the degree to which someone can have an influence in the consensus process is proportional to the quantity of economic resources that they can bring to bear.

Alternatively and optionally, the blockchain is a consortium blockchain, such as Hyperledger Fabric, where the consensus process is controlled by a pre-selected set of nodes, which for example may optionally be financial institutions. Such a blockchain is partially decentralized.

If the blockchain is private or permissioned—that is, centrally controlled by an operating entity to authorize participation—then optionally all members of the system as described by the present invention which need access are provided with cryptographic access and become members of the private or permissioned blockchain system, such as Hyperledger.

Hyperledger has its own set of protocols and consensus process, which may optionally be used with smart contracts, to prevent fraud.

One of ordinary skill in the art could easily select a distributed ledger and implement it within various embodiments of the present invention, for example according to information provided in “Blockchain Basics: Introduction To Business Ledgers” by Brakeville and Perepa, IBM, May 9, 2016.

A blockchain is a distributed database that maintains a list of data records, the security of which is enhanced by the distributed nature of the blockchain. A blockchain typically includes several nodes, which may be one or more systems, machines, computers, databases, data stores or the like operably connected with one another. In some cases, each of the nodes or multiple nodes are maintained by different entities. A blockchain typically works without a central repository or single administrator. One well-known application of a blockchain is the public ledger of transactions for cryptocurrencies such as used in bitcoin; however other applications include real estate, property transfer and non-cryptocurrency financial transactions. The data records recorded in the blockchain are enforced cryptographically and stored on the nodes of the blockchain.

A blockchain provides numerous advantages over traditional databases. A large number of nodes of a blockchain may reach a consensus regarding the validity of a transaction contained on the transaction ledger. Similarly, when multiple versions of a document or transaction exits on the ledger, multiple nodes can converge on the most up-to-date version of the transaction. For example, in the case of a virtual currency transaction, any node within the blockchain that creates a transaction can determine within a level of certainty whether the transaction can take place and become final by confirming that no conflicting transactions (i.e., the same currency unit has not already been spent) confirmed by the blockchain elsewhere.

The blockchain typically has two primary types of records. The first type is the transaction type, which consists of the actual data stored in the blockchain. The second type is the block type, which are records that confirm when and in what sequence certain transactions became recorded as part of the blockchain. Transactions are created by participants using the blockchain in its normal course of business, for example, when someone sends cryptocurrency to another person), and blocks are created by users known as “miners” who use specialized software/equipment to create blocks. Users of the blockchain create transactions that are passed around to various nodes of the blockchain. A “valid” transaction is one that can be validated based on a set of rules that are defined by the particular system implementing the blockchain. For example, in the case of cryptocurrencies, a valid transaction is one that is digitally signed, spent from a valid digital wallet and, in some cases, that meets other criteria. In some blockchain systems, miners are incentivized to create blocks by a rewards structure that offers a pre-defined per-block reward and/or fees offered within the transactions validated themselves. Thus, when a miner successfully validates a transaction on the blockchain, the miner may receive rewards and/or fees as an incentive to continue creating new blocks.

Preferably the blockchain(s) that is/are implemented are capable of running code, to facilitate the use of smart contracts. Smart contracts are computer processes that facilitate, verify and/or enforce negotiation and/or performance of a contract between parties. One fundamental purpose of smart contracts is to integrate the practice of contract law and related business practices with electronic commerce protocols between people on the Internet. Smart contracts may leverage a user interface that provides one or more parties or administrators access, which may be restricted at varying levels for different people, to the terms and logic of the contract. Smart contracts typically include logic that emulates contractual clauses that are partially or fully self-executing and/or self-enforcing. Examples of smart contracts are digital rights management (DRM) used for protecting copyrighted works, financial cryptography schemes for financial contracts, admission control schemes, token bucket algorithms, other quality of service mechanisms for assistance in facilitating network service level agreements, person-to-person network mechanisms for ensuring fair contributions of users, and others.

Smart contracts may also be described as pre-written logic (computer code), stored and replicated on a distributed storage platform (eg a blockchain), executed/run by a network of computers (which may be the same ones running the blockchain), which can result in ledger updates (cryptocurrency payments, etc).

Smart contract infrastructure can be implemented by replicated asset registries and contract execution using cryptographic hash chains and Byzantine fault tolerant replication. For example, each node in a peer-to-peer network or blockchain distributed network may act as a title registry and escrow, thereby executing changes of ownership and implementing sets of predetermined rules that govern transactions on the network. Each node may also check the work of other nodes and in some cases, as noted above, function as miners or validators.

Not all blockchains can execute all types of smart contracts. For example, Bitcoin cannot currently execute smart contracts. Sidechains, i.e. blockchains connected to Bitcoin's main blockchain could enable smart contract functionality: by having different blockchains running in parallel to Bitcoin, with an ability to jump value between Bitcoin's main chain and the side chains, side chains could be used to execute logic. Smart contracts that are supported by sidechains are contemplated as being included within the blockchain enabled smart contracts that are described below.

For all of these examples, security for the blockchain may optionally and preferably be provided through cryptography, such as public/private key, hash function or digital signature, as is known in the art.

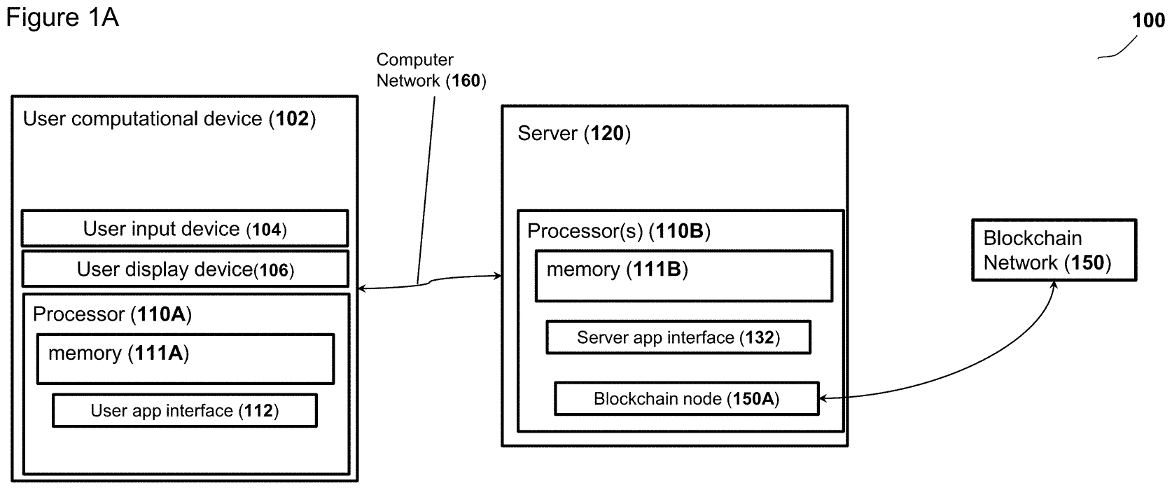

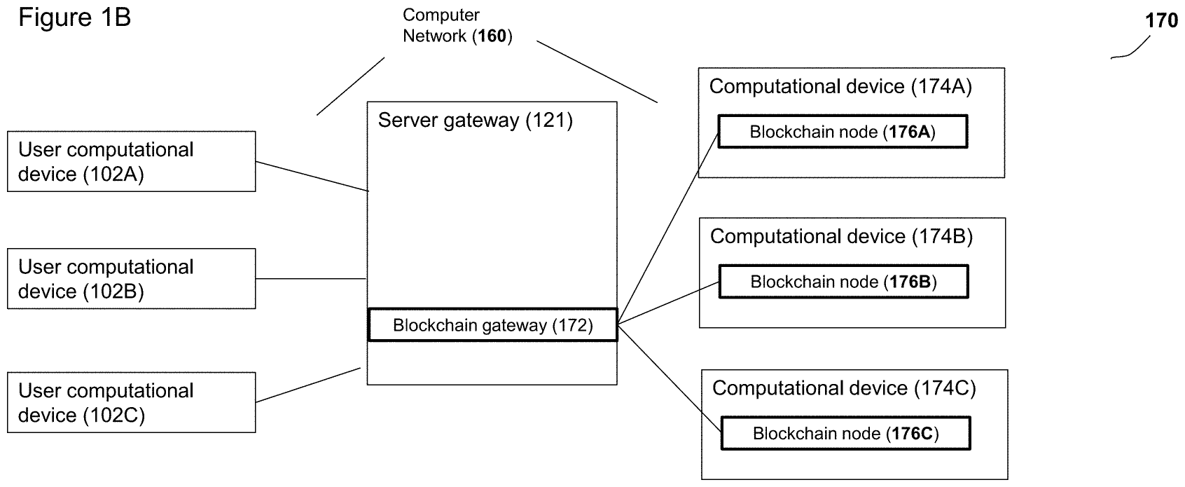

Turning now to the drawings, FIG. 1A shows a non-limiting exemplary system for supporting the sale, transfer and recordation of ownership of digital assets related to fashion according to at least some embodiments of the present invention. As shown in a system 100, there is a user computational device 102, which communicates with the server gateway 120 through a computer network 160. Server 120 may, for example, be implemented as a server gateway or may alternatively comprise a single server. Server 120 is able to communicate with a blockchain network 150 through a blockchain node 150A. User computational device 102 features a user input device 104, a user display device 106, a processor 110A, a memory 111A, and a user interface 112.

The user transfers commands through user interface 112. These commands are then sent to server 120, which through instruction stored a memory 111B and executed by processor 110B proceeds then to perform necessary actions. A server app interface 132 is able to receive these commands and to assist in the processing to understand what the commands mean and what they are for. The commands, for example, may include reading from blockchain node 150A or writing to blockchain node 158A, for example to transfer the information over blockchain network 150.

As used herein, a “user interface” 112 generally includes a plurality of interface devices and/or software that allow a user to input commands and data to direct the processing device to execute instructions. For example, the user interface may include a graphical user interface (GUI) or an interface to input computer-executable instructions that direct the processor to carry out specific functions. The user interface employs certain input and output devices to input data received from a user or output data to a user. These input and output devices may include a display, mouse, keyboard, button, touchpad, touch screen, microphone, speaker, LED, light, joystick, switch, buzzer, bell, and/or other customer input/output device for communicating with one or more customers.

A processor 110A performs instructions for operating the user computational device including with regard to the user interface 112. Such instructions are stored in the memory 111A. As used herein, a processor generally refers to a device or combination of devices having circuitry used for implementing the communication and/or logic functions of a particular system. For example, a processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processor may further include functionality to operate one or more software programs based on computer-executable program code thereof, which may be stored in a memory. As the phrase is used herein, the processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

FIG. 1B is an alternative implementation of a system or assisting in filing and interacting with multiple different blockchains. In this case, a system 170 again features user computational devices shown as 102A, 102B and 102C, but without further detail for the sake of clarity, server 120 is now preferably configured as a server gateway 121 featuring a blockchain gateway 172. Blockchain gateway 172 is in communication with a plurality of different blockchain nodes 176A, 176B and 176C. These different blockchain nodes are associated with separate computational devices, 174A, 174B and 174C. In each case, each node may be from a separate blockchain and blockchain gateway 172 may be able to communicate with multiple blockchains, for example, to read from or write to different blockchains represented by blockchain nodes 176A, 176B and 176C.

For both FIGS. 1A and 1B, the user is preferably able to access information and/or services on the blockchain, for example through blockchain nodes 150A, 176A, 176B and 176C. As described in greater detail below, these services include, without limitation, one or more of recording ownership of a digital fashion asset, receiving verification of authentication of a digital fashion asset, accessing media or other components associated with the digital fashion asset, and also accessing services or components associated with a physical fashion asset.

As used herein, the term “fashion asset” includes but is not limited to clothing, shoes, hats, belts, watches, jewelry, sunglasses, wallets, bags, purses and so forth.

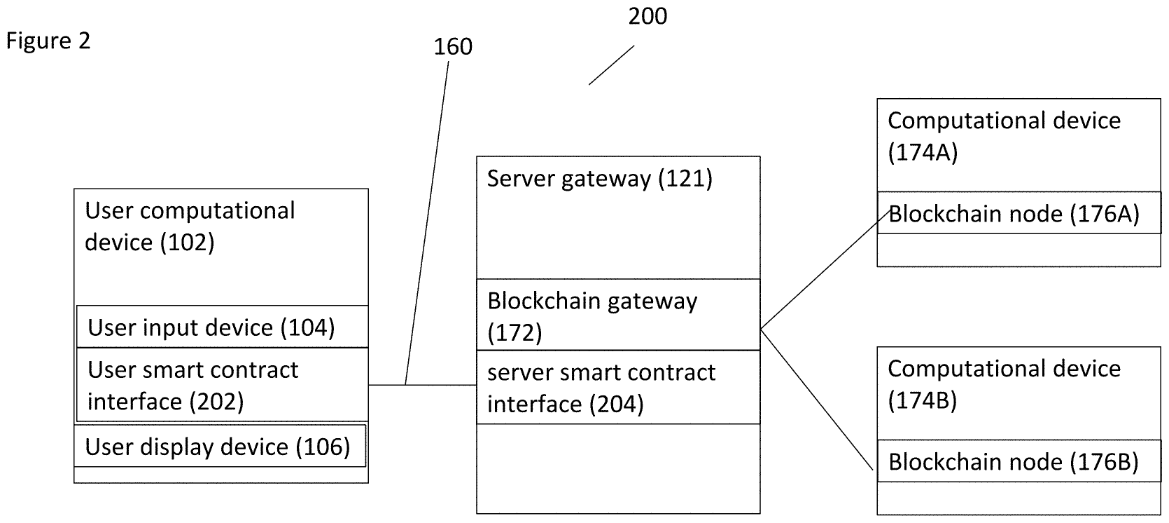

FIG. 2 shows a non-limiting exemplary system, again which supports reading from and writing to a plurality of different blockchain networks. However, in this case, user computational device 102 also includes the user smart contract interface 202, which enables the user, for example, to invoke smart contracts, to include instructions for smart contracts, to receive information about smart contracts, and this in turn communicates with the server smart contract interface 204. Server smart contract interface 204, upon receiving instructions from user smart contract interface 202, is able to preferably create smart contracts, provide data for the invocation of execution of smart contracts, potentially to create a changed smart contract, which is preferably written as an additional contract rather than amending the previous one, unless the blockchain permits such changes and so forth. All of these actions are preferably performed through blockchain gateway 172, communicating again with the plurality of different blockchains shown as blockchain nodes 176A and 176B.

The smart contracts may be used, for example and without limitation, to transfer ownership of a digital fashion asset, record ownership of a digital fashion asset, support remixing of such an asset, determine authentication of such an asset and so forth. Optionally, the smart contracts also support game play as described in greater detail below. For example, the smart contracts may be used to support ownership of game assets and transactions between players for assets. For example, players may buy or sell, or win or lose, such assets. Each time one of these situations occurs, an asset transfer is required to a cryptocurrency and/or cryptoasset wallet. Such a wallet is a blockchain wallet, holding a combination of currencies and/or digital assets that are stored on, and transacted through, one or more blockchains.

As another example, the smart contracts may execute through a game portal, such that the player may hold assets indirectly. Rather than having custody be provided through the cryptocurrency and/or cryptoasset wallet of the player, the player has wallet-less custody of assets. The game portal or another component of the system may hold such assets in a wallet that is held on behalf of the player. Blockchain-based transactions may then occur on behalf of the player through the blockchain wallet held by the game portal, and executed through smart contracts. In this implementation, but without wishing to be limited by a closed list, the smart contracts are particularly useful to support the correct, automatic execution of transactions and to reduce fraud, or unexpected actions.

Optionally, smart contracts may also be used to support automatic access to services and/or components, for example according to a physical location of a user. The game may for example comprise a treasure hunt format, in which the user searches for assets. The assets may be digital assets that appear to exist in the physical world, for example as an augmented reality (AR) overlay, which may be viewed through a mobile telephone app or other computational device application.

For example, the treasure hunt may involve the search for digital fashion assets, such as sneakers. When such fashion assets are made available in the physical world, they typically are brought to the market in a limited number, referred to as a “drop”. For the game, a “drop” of digital fashion assets, such as digital sneakers, would be a plurality of such assets made available in a limited number, and optionally also in a limited location. A user, while playing the game, would seek to collect such digital fashion assets, for example by moving through the physical world while engaging with an application on a computational device.

To further engagement with the physical world, the player may be encouraged to take photos of real (physical) sneakers in the physical world, and then to upload these photos. These photos may then form part of game play and/or may be connected to digital fashion assets.

Also optionally, smart contracts may be used for authentication of a physical asset according to an authenticator. Such smart contracts may for example interface with dapps—distributed autonomous applications. The game portal, or another user interface or other type of interface, may interact with a dapp. For example, if the user wishes to engage in a transaction involving transfer of ownership, whether to or from the user, then the user may interact with a software interface that invokes a dapp. Dapps may be used for example to support transaction automation through the game portal, in which the user does not hold a user wallet, but rather the wallet is held on behalf of the user by the game portal.

Optionally, whether through a game or another type of user application interaction, the smart contracts may be used to support ownership transfer of tokens. Preferably, these are NFTs (non-fungible tokens), which are a type of blockchain token that represents a digital asset. Each token preferably has an associated image and set of data about its attributes. This image and data can be fetched from the blockchain by a user (for example through a dapp or other supporting application), game, or application. Such a token may be issued as part of a limited digital series, for example as an NFT, that can be tradeable, collectable, auctionable. The token may also be issued to tokenize a real world asset for example as a certificate of ownership/authenticity.

Tokens may be used in a variety of ways, including but not limited to: Trading Cards, Collectibles, Game Assets, Keys, Representations of Real World Assets, Extensions Compatible with Applications. The extensions may be used for execution of further actions by using a token, in response to token ownership transfer, and so forth.

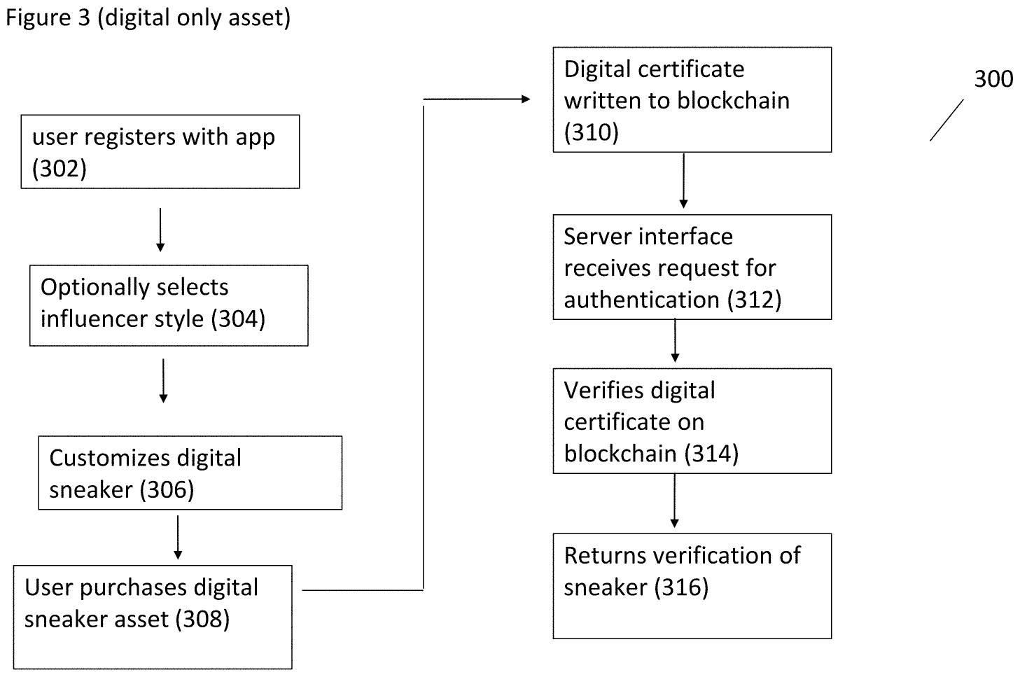

FIG. 3 shows a non-limiting exemplary method for enabling a user to customize a fashion item or asset, and to then have the certificate of ownership written to the blockchain. In this particular case, the non-limiting example of a fashion item is a sneaker, but of course other fashion items could also have their ownership written to the blockchain and can also have their ownership verified from the blockchain, for example. Preferably in this case, the method relates to a digital asset, which may for example be a digital only asset, as opposed to also having a corresponding asset featured in the physical world. For example, a digital asset may comprise a digital pair of sneakers only, rather than a physical pair of sneakers, or a combination of a digital pair of sneakers and a physical pair of sneakers.

As shown in the method 300, the process begins when the user registers with the app at 302. The user may then optionally select an influencer style 304 or some other type of style or template for creating the fashion item, which in this case is a pair of sneakers. These are then customized as the digital sneaker at 306. Such customization may also be performed automatically through the system as described in great detail below. The user then purchases the digital sneaker asset at 308. An additional certificate is written to the blockchain at 310, which enables the user to receive ownership of the asset. The server interface receives requests for authentication at 312. The server interface may be the previously described server interface, which is able to interact with one or more blockchains. The server then verifies the digital certificate on the blockchain 314 and returns verification of the authenticity of the digital assets such as the sneaker, and/or of ownership of that sneaker, at 316.

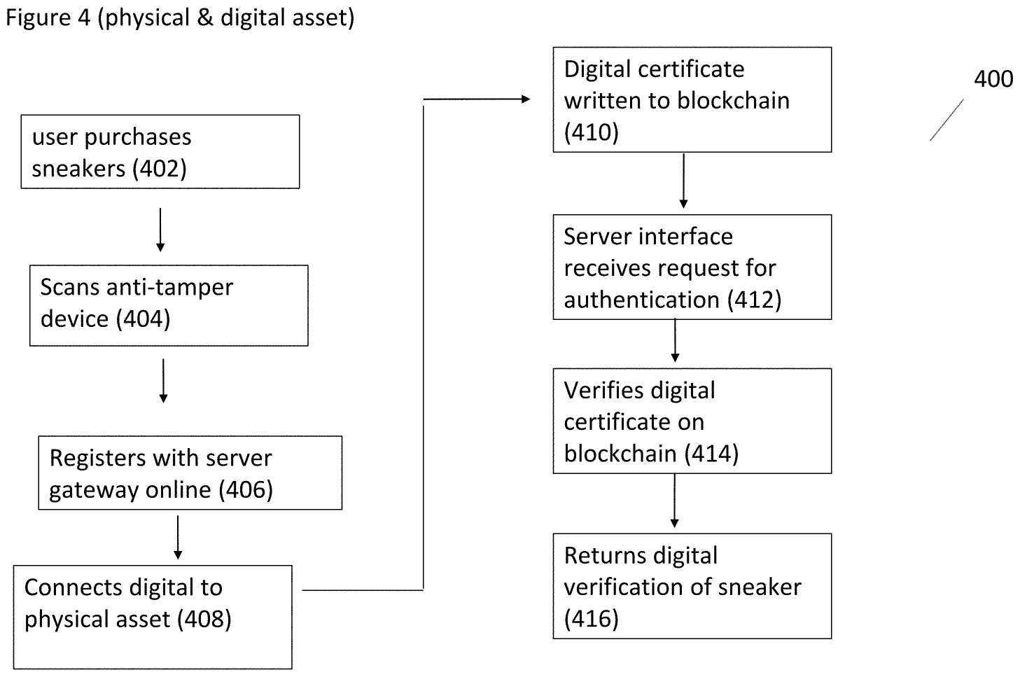

FIG. 4 relates to a non-limiting exemplary method which is operative for a combined set of assets, which include physical and digital assets, for example. Optionally, this method may also be used for a physical only set of assets. In this case, the method again relates to a fashion item. In this case, the fashion item is a pair of sneakers, and is at least a physical pair of sneakers. As shown in the method 400, the process begins when the user purchases physical sneakers at 402. The user, the store or a third party then scans the anti-tamper device at 404. This anti-tamper device may for example be integrally formed with the sneaker, attached to the sneaker, or otherwise combined with the sneaker so that the sneaker, as a physical pair of sneakers, can be authenticated.

The user then preferably registers with the server gateway online at 406, and then connects to a physical asset at 408. If there is no digital asset in the sense of having a digital pair of sneakers, optionally then such a connection is only to connect the physical asset to a digital representation online, so that the physical asset may be recorded online, for example, through the blockchain. Next a digital certificate is written to the blockchain of 410, preferably at least for the physical asset but optionally also for both a physical and a digital asset. At 412, the server interface receives requests for authentication, and the server then verifies the digital certificate on the blockchain at 414 as previously described. The server then returns a digital verification of the sneaker 416. Again, such a digital verification process may be performed for the physical asset, but may also be optionally performed for the digital asset as well.

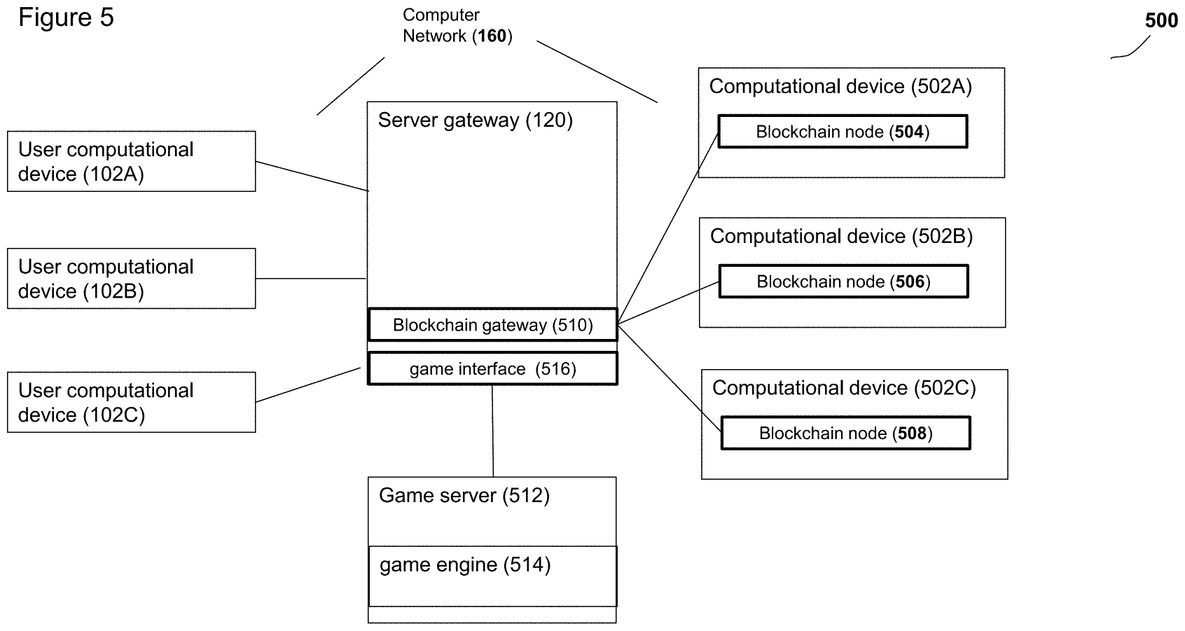

FIG. 5 shows a non-limiting exemplary method, which combines some of the previous embodiments involving interactions of most multiple user computational devices with a server gateway that is able to access a plurality of different blockchains and is also able to access a game server to support gaming. For example, as previously described, the server gateway may include software to automatically set up a gaming wallet for the user and may also hold that wallet in custody for the user.

In a system 500, again, there are a plurality of items such as user computational devices, 102A, 102B, and 102C, which are the same or similar to those as previously shown. But in this case, new and additional components include a game interface 516, which is operated by the server gateway 120. It is in communication with a game server 512 and a game engine 514 that supports gameplay through user computational devices 102A to 102C.

A blockchain gateway 510 is able to communicate with a plurality of different blockchain representatives, blockchain nodes 504, 506 and 508. In this case, for example, these different block chains may include permissioned and permissionless blockchains. They may follow very different protocols. They may be built over very different types of blockchains or blockchain constructs, and therefore they're shown as being separate. Each such blockchain node, 504, 506 and 508 is operated by a computational device shown as 502A, 502B and 502C. Again, the combination supports gameplay through these computational devices, but also through reading information from an optionally writing information to one or more of the different blockchains.

Blockchain gateway 510 may comprise one or more IBC implementations. An IBC is an implementation that uses the inter-blockchain communication protocol, which features deterministic processes that run on independent blockchains to support cross-chain communication. Such cross-chain communication may for example include support for payment in various cryptocurrencies and may also include support for asset transfer between different blockchains. Blockchain gateway 510 also preferably supports interactions between game engine 514 and blockchains 504, 506 and 508. For example, blockchain gateway 510 preferably supports wallet-less asset custodianship, so that even if a user (operating one of user computational devices 102A-102C) did not have a blockchain-accessible or blockchain-supporting wallet, or other software, such a user could still hold, receive and transfer assets through blockchains 504, 506 and 508. Alternatively or additionally, blockchain gateway 510 may support users wishing to employ such a wallet for gameplay.

According to at least some embodiments, blockchain gateway 510 uses ERC-1155 (also referred to herein as ERC1155) to support gameplay and interactions between user computational devices 102A-102C and blockchain-based actions and/or assets. ERC-1155 is an Ethereum-based multi-token standard, according to which both fungible and non-fungible tokens may be issued. Blockchain gateway 510 preferably employs this standard to issue tokens and assets associated with gameplay. The game may be a video game or another type of game. The exchange of assets and/or contracts may be performed according to the Ox protocol of ethereum for example. As a non-limiting example, a Dutch auction format may be used for asset distribution. Preferably, the game is a video game or a game having video components, such as an AR (augmented reality) or VR (virtual reality) game. Optionally any type of e-sports may be supported with in-game tokens and/or assets and/or digital currency through for example blockchain gateway 510.

ERC1155 supports tokenization of various in-game assets. These assets may then be traded and/or bought with a cryptocurrency or virtual currency in a decentralized manner, for example through smart contracts. The smart contracts may be implemented according to Solidity, for example. As a non-limiting example, for an NBA (National Basketball Association) based game, the ERC1155 standard may be used to issue team cards, career statistics or moves, player cards and virtual currency. Players of the game (for example, users of user computational devices 102A-102C) may use the virtual currency, cryptocurrency and/or digital assets to obtain points for boosting the performance of an NBA player (whether completely virtual, or partially or completely based on an existing player). As a non-limiting example of a virtual asset, a player may hold a digital or virtual fashion item, such as a digital pair of sneakers for example. Such a player may choose to trade this digital pair of sneakers for virtual currency, cryptocurrency and/or boosting points for a player. Brand owners (through a brand owner computational device, not shown, and/or through server 120) may provide bonuses if a player has a particular brand of digital fashion item, or may encourage a game player (for example, users of user computational devices 102A-102C) to purchase or otherwise obtain the particular brand of digital fashion item. For example, the digital fashion item, such as digital sneakers, may be associated with boost (increased performance) points during gameplay, if worn by a virtual player.

Optionally, the brand owner (through a brand owner computational device, not shown, and/or through server 120) may create a virtual digital store, holding such digital assets. The digital store may include visuals of digital fashion items, such as digital sneakers for example. A game player may be able to view their virtual player within such a store, and virtually “try on” the digital fashion items. The digital store may be separately branded.

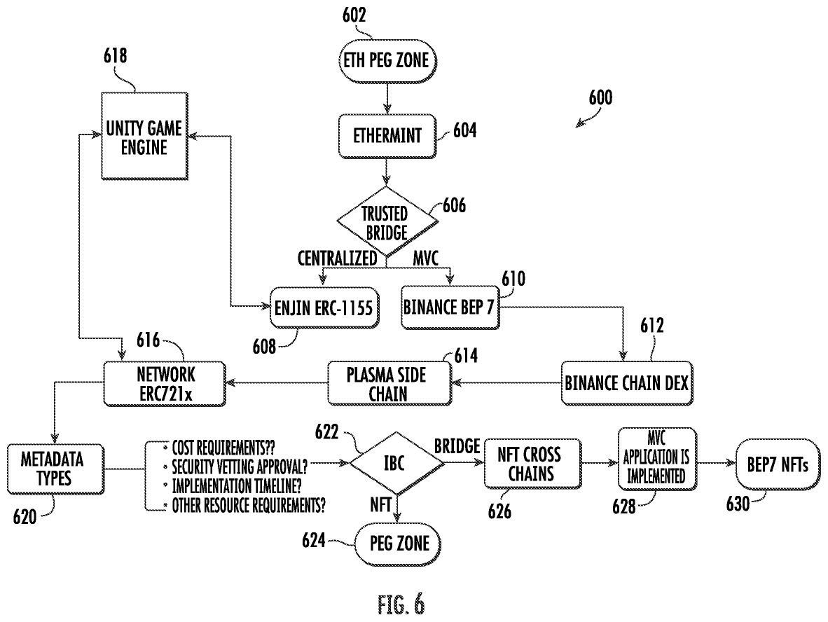

FIG. 6 shows a non-limiting exemplary system for supporting communication through a plurality of different blockchain components and across different blockchains using different protocols. The system preferably supports communication across a plurality of different blockchains, optionally having different blockchain protocols. Such communication is preferably supported through bridging chains, such that cross-chain transactions may occur. Certain bridging chain protocols are known and include for example the Ethereum 2.0 format for supporting interoperability. Such interactions may be supported by smart contracts that can cross-collateralize bitcoin to ethereum. The type of blockchain used for asset storage is therefore decoupled from the type of payment mechanism, whether fiat currency, or one or more cryptocurrencies.

As shown in a method 600, the process starts with an Ethereum peg zone 602, which is an optional implementation to support cross-blockchain interoperability. Bitcoin and, under some circumstances, Ethereum currently operate under conditions of probabilistic rather than absolute finality. Such lack of probabilistic finality may cause problems when transferring assets across blockchains. Peg zones are an optional solution to this problem, which are helpful for supporting user payments of various types, including but not limited to fiat currency, or one or more cryptocurrencies.

Ethereum peg zone 602 communicates with Ethermint at 604. Ethermint is an implementation of Ethereum over the Tendermint service, which supports finality and proof of stake, rather than proof of work, for mining and block creation. Ethermint then communicates with a trusted bridge 606, at which point the process may split. Alternatively, game play may be controlled through a central game engine (not shown). The split in this non-limiting example shows an implementation that involves a separate game engine that is separated from a token based blockchain system for holding digital assets. The split for example may be used to support API connections for game developers, to connect tokens to game play, or 3d model of sneakers. Such API connections may also be provided through a central game engine (not shown).

For example, in this non-limiting embodiment, the process splits with the process continuing to Binance BEP 7 at 610, and then with a Binance Chain DEX at 612. The Binance BEP 7 protocol natively supports the creation of non-fungible tokens (NFT) on the Binance blockchain.

Next, the process continues with a plasma side chain at 614. Plasma side chains are used for more rapid calculations in Ethereum. The side chain in turn communicates with a Network ERC 721x 616. Component 616 may be implemented through any component that connects to the game engine, preferably through an ERC 721x implementation. Component 616 may provide a prebuilt connection to the Unity game engine, which is the non-limiting, exemplary game engine shown herein.

Preferably, the component at 616 also receives input from Unity game engine 618 or any other type of game engine. Unity game engine 618 also preferably communicates with ERC1155 at 608. ERC1155 is the smart contract associated with execution of game play as previously described. In this non-limiting example, component 608 is shown as an “Enjin” component, which is an ecosystem of applications built over Ethereum blockchain; other implementations are possible (not shown). All communication with game engine 618 is preferably bidirectional. Although game engine 618 is shown as a Unity game engine, other types of game engines may be implemented as well (not shown).

From 616, the process then preferably continues at 620 with metadata types being collected with information. Functions and components 620-630 are optional, but may be implemented to support an MVC (minimum viable connection) for NFTs (non-fungible tokens) through the Binance system, with IBC implementations. As for FIG. 5, an IBC supports cross-chain communication. For example, cross-chain asset swaps are supported by IBC components.

Metadata types and information are collected at 620 to support interactions through the Binance system. The collected information is then fed into an IBC 622, and also through the non-fungible token back to a different peg zone 624. IBC 622 supports inter blockchain communication and is a component that operates according to the above described inter-blockchain communication protocol. The non-fungible token is recorded on a cross-chain at 626, and then MVC application is implemented at 628. The MVC application at 628 optionally enables different NFTs, non-fungible tokens, to be recorded or invoked at 630. These NFTs may have been created or recorded on a plurality of different blockchains; the inter-blockchain communication protocol supports cross-chain transfer and asset recordation for these NFTs.

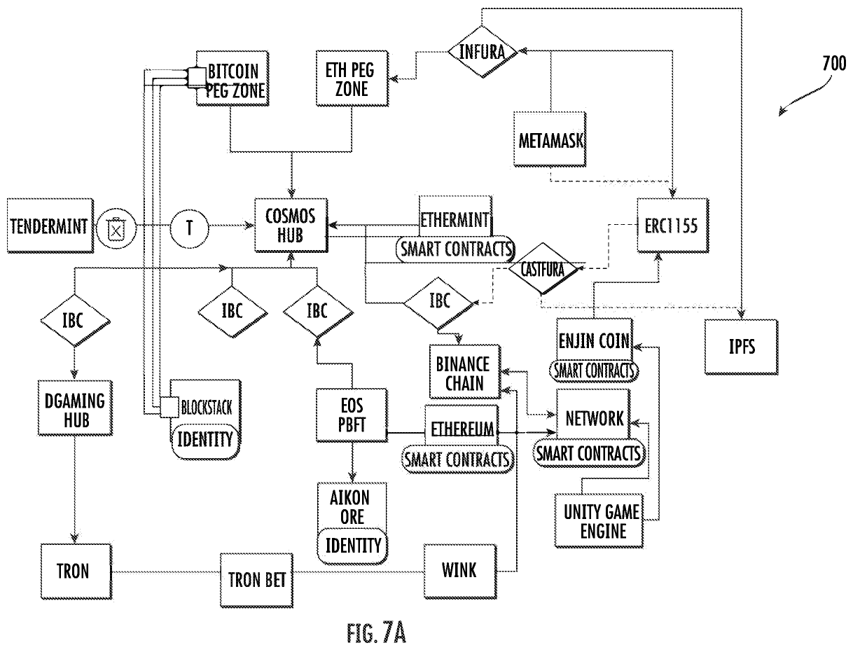

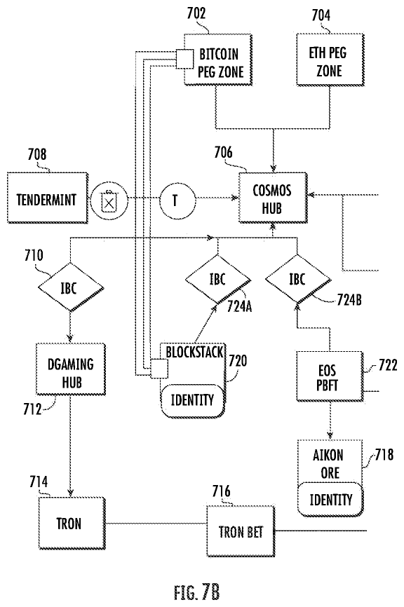

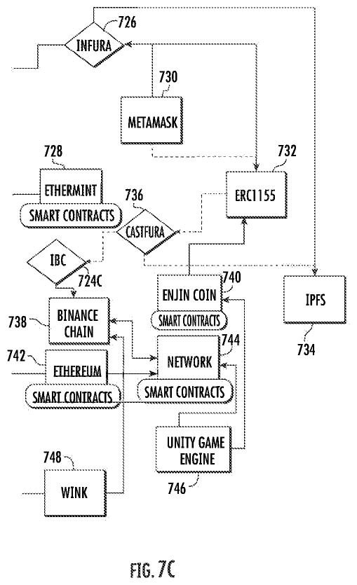

FIG. 7A to 7C show a system 700 with a variety of components, which is preferably able to support gameplay through a plurality of blockchains and optionally through a plurality of engines. The left side of the diagram shown in FIG. 7A is shown now in FIG. 7B. The right side of the diagram shown in FIG. 7A is shown now in FIG. 7C.

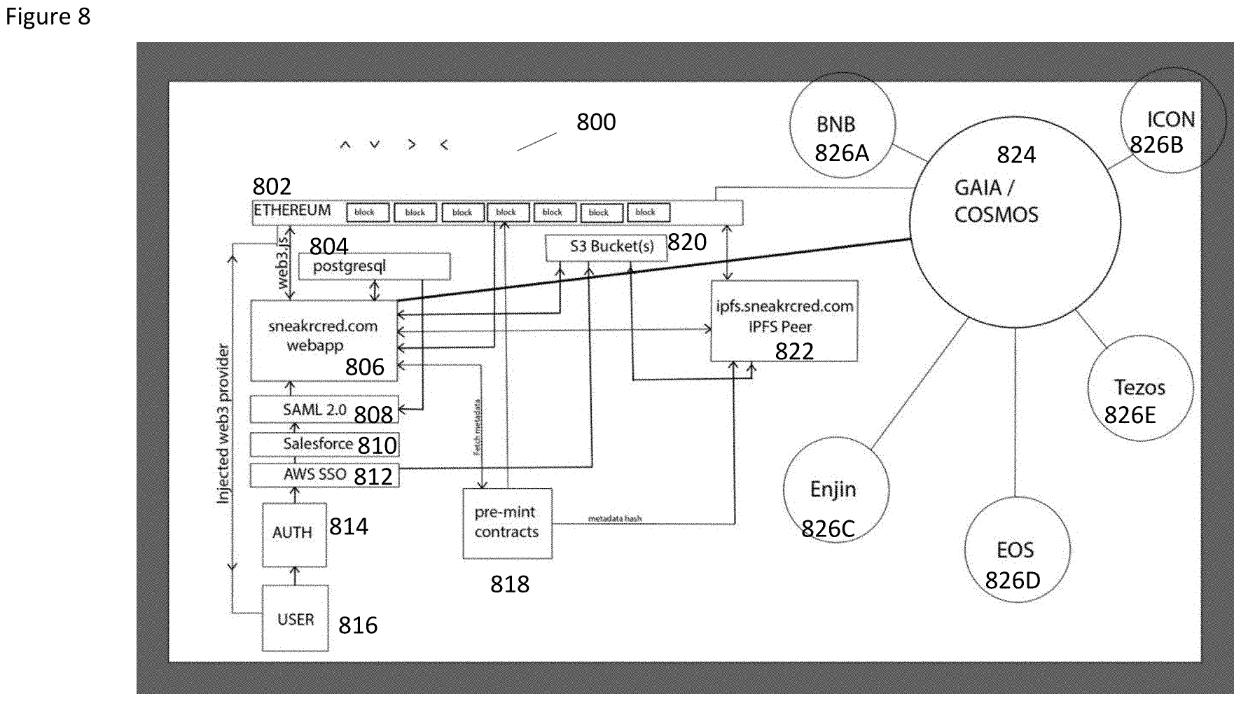

Turning now to FIG. 7B, as shown, peg zones for Bitcoin at 702 and Ethereum at 704 preferably provide information to Cosmos Hub 706. Cosmos Hub 706 is, in turn, preferably in communication with a Tendermint implementation 708. Cosmos Hub then is a focal hub around which gameplay and also recording of information to and reading of information from various blockchains may be provided. Cosmos Hub communicates with plurality of IBCs, shown as IBC 724A and 724B, with an additional IBC 724C being shown in FIG. 7C. The IBCs, for example, support communication with an EOS 722, and optionally with other components as well. EOS 722 provides a front-end to the EOS NFT token standard and also supports communication with AIKON ORE 718 for user identification and single user sign on (for example through Google or Apple). A block stack 720 may then also communicate with the Bitcoin peg zone 702, and optionally with additional components as well such as IBC 724A. Block stack 720 preferably supports proof of work to proof of stake connection, between bitcoin or other cryptocurrencies to the token system (which is preferably proof of stake), through the Gaia protocol at Cosmos Hub 706 (see also FIG. 8).

In addition, IBC 724A may also communicate with another IBC 710. IBC 710 in turn preferably communicates with a gaming hub 712. Gaming hub 712 preferably communicates with TRON 714, and then with a TRONbet 716. TRON 714 and TRONbet 716 are optionally implemented to support connections to Binance chain BEP7 coins, which may be used to support transactions for NFTs as described herein. These processes continue in FIG. 7C.

FIG. 7C shows a continuation of system 700 from FIG. 7B. In this non-limiting example, Infura 726 preferably communicates with the Ethereum peg zone 704 (shown in FIG. 7B). Infura 726 preferably also communicates with IPFS 734, to act as a bridge with Ethereum peg zone 704. IPFS 734 may be used to store digital assets, such as for example associated media files or other components related to such assets. In addition, MetaMask 730 may be used to handle payments, for example, through execution of ERC1155 at 732. In addition, from FIG. 7B it is shown that Cosmos Hub 706 preferably communicates with Ethermint 728. In addition, ERC 1155 preferably communicates with Casfura 736. Casfura 736 supports communication with computational devices that create and store digital assets, and media components associated with such digital assets.

Casfura 736 in turn communicates with IBC 724C, and provides support for the communication with additional components such as blockchains Binance Chain 738 and Ethereum 742. From ERC1155, optionally there is a direct communication with an enjin coin 740 to support bidirectional communication with the game engine, such as for example the Unity game engine. This connection also supports the MVC between enjin coin 740, or another blockchain, and a game engine such as the Unity game engine.

Further communication may be provided between the Binance Chain 738 and the Network 744, and all of this may optionally communicate with Unity game engine 746, again to support the MVC. Also, preferably communication is performed between TRONbet 716 from FIG. 7B, and also wink 748. Wink 748 supports connection to the Binance chain. The TRON/TRONbet and Wink components are interoperable and may be used alone or in combination.

FIG. 8 shows a non-limiting exemplary system in more detail for supporting various communications, including optionally smart contract execution. As shown in the system 800, there is provided an Ethereum stack 802. This preferably communicates with a centralized fashion web app 806, which also supports communication to a database 804. In addition, the web app preferably communicates with a SAML 808, Salesforce 820, and AWS 812, again to support actual execution of the web app. It also preferably is able to communicate with the Ethereum Stack 802. In addition to support authentication, for example, an authentication block at 814 is provided, and then the user is able to authenticate him or herself to the web app 806 through a computational device 816 interacting with authentication module 814.

Ethereum Stack 802 is also preferably in communication with premint contracts 818, and also within IPFS peer 822. IPFS peer 822 supports storage of digital media assets and also is able to provide these assets, for example to web app 806. IPFS peer 822, Ethereum Stack 808 and premint contracts 818 all preferably combine to support communication with a Gaia Cosmos Hub 824. Gaia Cosmos Hub 824 is also preferably able to communicate with web app 806. Gaia Cosmos Hub 824 can support communication and interconnectivity between a plurality of different types of blockchains, including without limitation BNB 826A, ICON 826B, Tezos 826C, EOS 826D, and Enjin 826E.

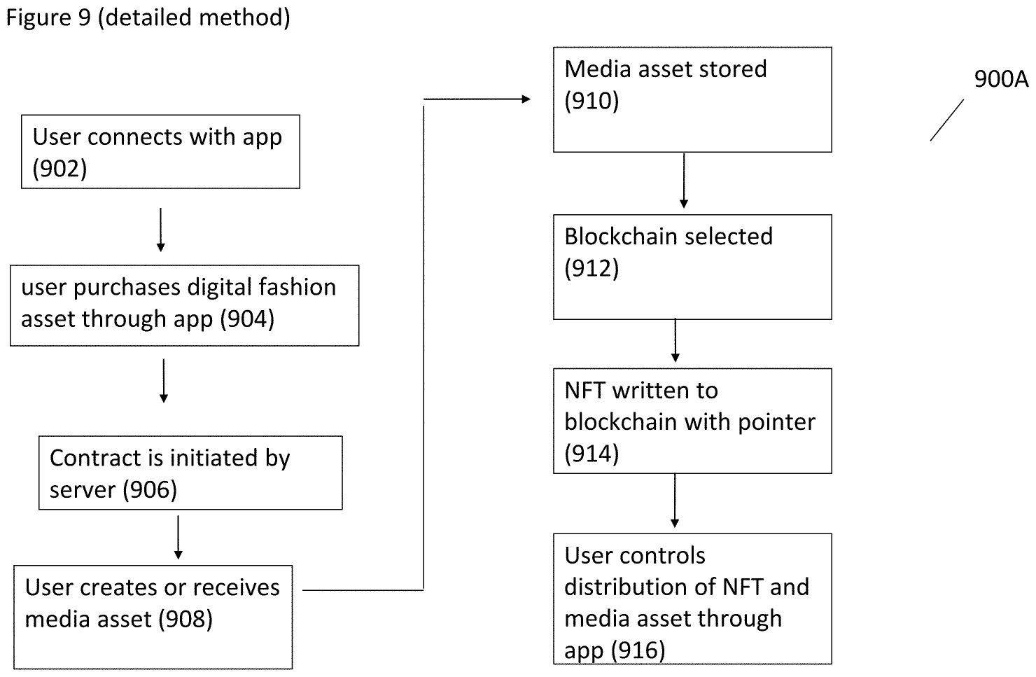

FIG. 9 shows a non limiting exemplary method for supporting purchases of a digital fashion asset and then of writing that asset to a blockchain. For example, to be able to control distribution. As shown in the method 900, the user connects with the app at 902, for example with registration and optionally then using the app. The user purchases a digital fashion asset through the app at 904. This for example, could be sneakers or any other fashion asset as described herein. A contract is initiated by the server at 906. The user creates or receives the media asset at 908. So for example, the user may receive the media asset, the digital fashion asset, but may then end up customizing it or combining it in some way. Then the media asset is stored at 910. This media asset represents the visual or other aspects of the digital fashion asset. A blockchain is selected at 912, optionally from more than one blockchain. Then the NFT is written to a blockchain with a pointer at 914. The NFT is the non-fungible token, is written to the blockchain with the pointer, and the user controls distribution of the NFT and the media asset through the app.

These items for example can be co-distributed. The media asset may be co-distributed with the NFT, or otherwise provided in a connected manner. The NFT is written to the blockchain with the pointer, such that preferably the pointer indicates the location where the media asset is stored, so that the two become connected. This supports control of distribution and also of ownership. A system such as IPFS may be used for storage of the media assets.

Optionally, an alternative method, users may exchange and manage digital and physical goods that have a non-fungible token associated with it. The method begins with a user connecting with the creating or purchasing a digital fashion good from a seller. The user may use, store, or exchange the digital fashion good.

Next, these goods may be stored within a standard Web3 wallet and ported in and out of gaming platform environments. This model allows for interoperability across Web3 systems.

Optionally, another alternative method, user may create or purchase digital fashion goods from sellers, where the user may use, store or exchange the good. The method begins with a user creating or purchasing a digital fashion good from a seller. Next, these goods may be stored within a standard Web3 wallet at and ported in and out of gaming platform environments.

This model allows for interoperability across Web3 systems and also incorporates real-time off-chain data into it's smart contracts. This off-chain data is programmed to be Verifiably Random Data that enables it to be responsive to off-chain events like location data, gaming inputs and other social platform events data. The process model for making physical and digital goods interoperable involving interchain NFTs. Gaming and immersive applications consume digital goods on chain allowing users the ability to express them as digital fashion or convert physical goods into digital artifacts.

Finally, the user exchanges the token associated with the object as it's underlying unique and recorded identity.

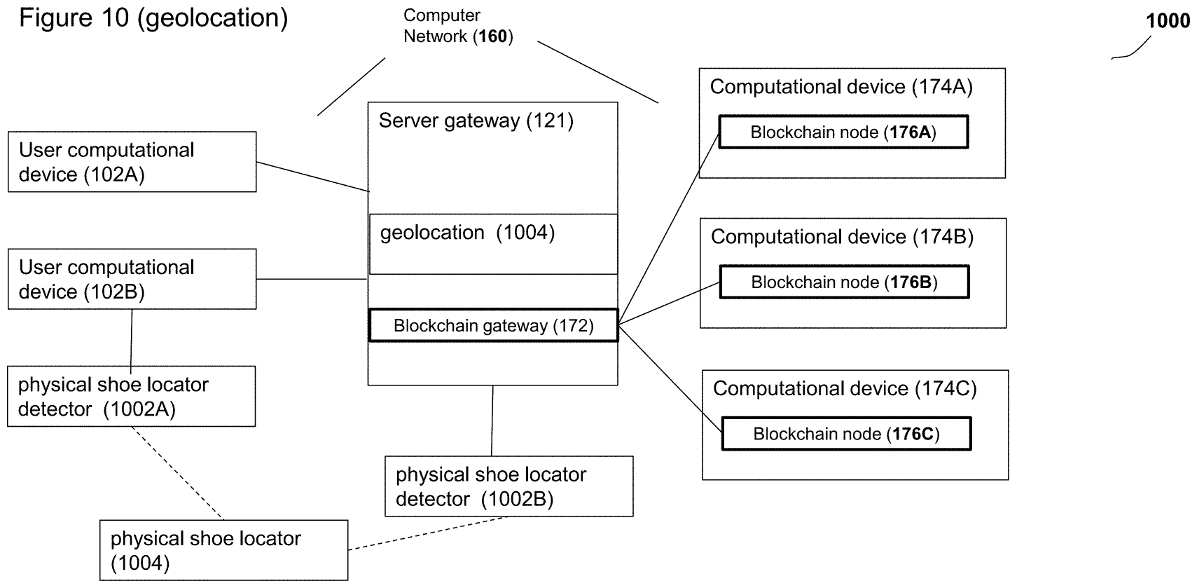

FIG. 10 is a non-limiting exemplary system for geolocation in which the physical location of a pair of shoes in this case, but optionally any fashion asset is detected and then one or more other actions may then be performed through the system. In a system 1000, a number of components are shown which are the same or similar to those in previous drawings, and they have the same reference number. System 1000 preferably features a physical shoe locator 1004, which may be used to detect the location of a shoe or other fashion asset.

As an example, the physical shoe locator in this case could be a device for supporting detection of the location of a shoe. Such a device may for example be passive or active. The shoes may have an RFID tag or something which can be read. The shoes may also have an active transmitter which can be detected.

Optionally detection of physical shoe locator 1004 is performed by a physical shoe locator detector 1002A or 1002B. Detector 1002A is shown as being operated by user computational device 102B. Detector 1002B is shown as being operated by server gateway 121. For example, if user computational device 102 B comprises a smartphone, then the physical shoe locator detector 1002A would be used for the user to prove the location of the shoes. Physical shoe locator detector 1002A could be an app running on the user computational device 102B or could comprise hardware to somehow interact with the shoes. The location information is passed to the physical shoe locator detector 1002A through user computational device 102B and then on through server gateway 121.

Alternatively, remote physical shoe locator detector 1002B may actually be able to read an active transmission, for example, if the location device in the shoe is able to communicate with a telephone network. Preferably server gateway 121 has a geolocation module 1004 for determining the geolocation of the shoes, which are located with one of the physical shoe locator detectors, 1002A or 1002B.

The location may then be written to one of the blockchain nodes, shown as blockchain nodes 176 A to C. But alternatively blockchain gateway 172 may read information from the blockchain so that for example, when the user is at a particular location, server gateway 121 determines whether an action should be taken, such as for example executing a smart contract, providing rights to the user (through user computational device 102B) to access certain digital media assets or other digital assets. The user could also receive services through user computational device 102B.

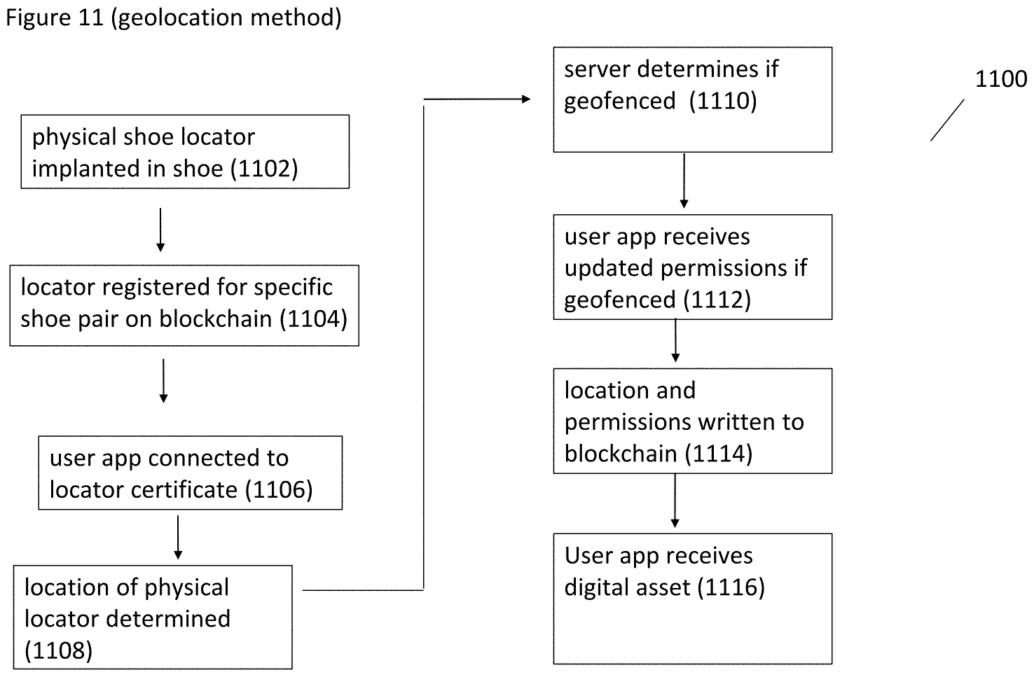

FIG. 11 relates to a non-limiting exemplary geolocation method. Once the physical shoes have been geolocated, that is the location of the user and the shoes has been determined, then this method is preferably performed. As shown in a method 1100, a physical shoe locator is implanted in or attached to the shoe at 1102. The locator is registered for a specific shoe pair on the blockchain 1104, the user app is connected to the locator certificate at 1106, and then the location of the physical locator is determined at 1108. The current physical location is determined for the locator device which is connected locally through a user computational device or remotely through a server. Preferably the server determines if the physical locator is located within a particular geo-fenced area at 1110. Such a geo-fenced area may include for example, Yankee Stadium, the City of New York or a particular store. The store could be for example the shoe store of a particular brand. Whatever the geolocation is, the server determines if the shoes are physically located within the geo-fenced area, the user app may, for example, receive updated permissions of geo-fence at 1112. These may include access to digital media assets, or other permissions, or even a prize, which could be the form of the permission. The location of permissions are optionally written to the blockchain in 1114 and then the user app receives the digital asset at 1116, or the prize or some other benefit from being within the geofenced area.

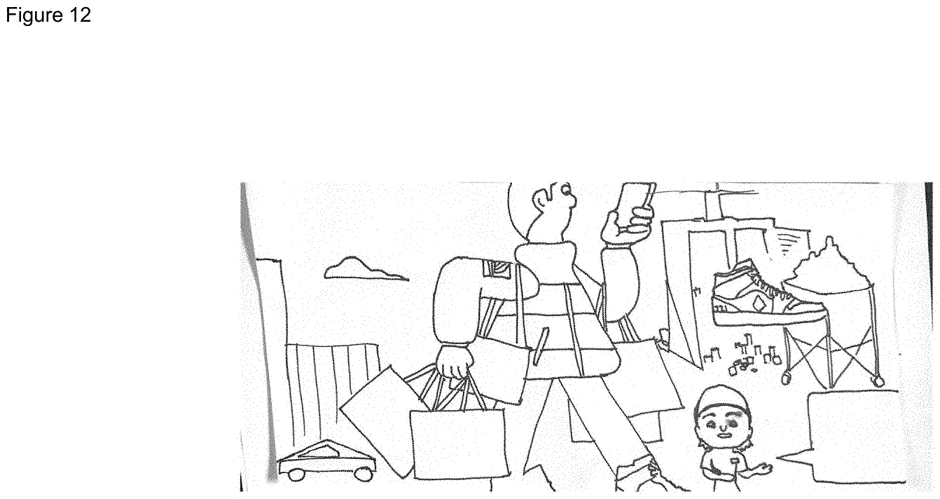

FIG. 12 shows a non-limiting, exemplary illustration of a scene from a game, featuring a digital fashion item. Two human figures are shown, with the digital fashion item shown as a sneaker. The sneaker may have its color, shape, pattern and the like determined through digital remixing. Such digital remixing may be performed by a remixing engine, which may be at least partially controlled through a brand owner computational device (not shown). Additionally, access to the sneaker, as well as the user's ability to make changes, may be determined through an auction. For example, the user may purchase one or more tokens through the auction. As a result, the user may be able to purchase asset “blanks”, which enable the user to make changes, for example through digital remixing. Digital remixing includes adding, changing, or subtracting features of a digital asset, including but not limited to shape, pattern and color. To support the attractive remixing of features, preferably color combinations are limited or selected according to a color remixing algorithm. Remixed digital assets, having remixed features, may be referred to as “spawn” of an original digital asset or blank.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A system for digital fashion asset management through a blockchain, comprising a user computational device, a server and a computer network for connecting said user computational device and said server; wherein said user computational device comprises a user interface and wherein said server comprises a blockchain interface, such that interactions through said user interface for digital fashion asset management are recorded on the blockchain through said blockchain interface, wherein each fashion asset is connected to an NFT (non-fungible token).

2. The system of claim 1, wherein said blockchain comprises a plurality of blockchains, the system further comprising an IBC (inter blockchain protocol component) for supporting transfer of said NFTs across blockchains.

3. The system of claim 2, further comprising an IBC for supporting payment for said NFTs through a plurality of cryptocurrencies.

4. The system of claim 3, wherein said cryptocurrencies are selected from the group consisting of ether, bitcoin and ERC-compliant cryptocurrencies.

5. The system of claim 4, wherein said ERC-compliant cryptocurrencies comprise ERC-20 tokens.

6. The system of claim 5, wherein said digital fashion asset comprises said NFT and a pointer to at least one media component, wherein said NFT and said pointer are stored on said blockchain.

7. The system of claim 6, further comprising at least one smart contract on said blockchain, wherein said smart contract is executed according to an instruction received from said server, said user interface or both, for determining an asset transfer of said digital fashion asset.

8. The system of claim 7, wherein said server further comprises a digital remixing engine, wherein said digital remixing engine supports remixing of a plurality of features of said fashion asset to form a changed or updated fashion asset.

9. The system of claim 8, wherein said remixed features are selected from the group consisting of color, shape and pattern.

10. The system of claim 9, wherein said digital remixing engine receives a plurality of fashion asset blanks and creates a fashion asset from each blank.

11. The system of claim 10, wherein said digital remixing engine remixes a plurality of features for a fashion asset blank to create a spawn asset.

12. The system of claim 11, further comprising a brand owner computational device, wherein a fashion asset is at least partially controlled through said brand owner computational device.

13. The system of claim 12, wherein said brand owner computational device determines a limiting of remixing by said digital remixing engine.

14. The system of claim 13, wherein said digital fashion asset mirrors a physical fashion asset.

15. The system of claim 14, wherein said digital fashion asset is connected to a physical fashion asset, the system further comprising a geolocator, said geolocator determining a location of said physical fashion asset and providing a digital fashion asset award according to said location.

16. The system of claim 15, wherein a fashion asset is selected from the group consisting of clothing, shoes, hats, belts, watches, jewelry, sunglasses, wallets, bags, purses and luggage.

17. The system of claim 16, wherein said fashion asset comprises sneakers.
